(19) United States
(12) Patent Application Publication
(10) Pub. No.: US 2024/0209605 A1
(43) Pub. Date: Jun. 27, 2024

(54) SINK ACCESSORY RAILING SYSTEM

(71) Applicant: Mila International Inc., Huntington Beach, CA (US)

(72) Inventor: Shujen YU, Huntington Beach, CA (US)

(73) Assignee: Mila International Inc., Huntington Beach, CA (US)

(21) Appl. No.: 18/288,346

(22) PCT Filed: Jul. 13, 2021
(86) PCT No.: PCT/US2021/041409

§ 371 Date: Oct. 25, 2023

(51) Int. Cl. E03C 1/186; E03C 1/18

(52) U.S. Cl. CPC E03C 1/186; E03C 1/18

(57) ABSTRACT

A sink assembly includes a sink basin including a bottom surface having a drain and four side walls extending upward from the bottom surface. A first sidewall of the four side walls is provided with a first series of spaced apart apertures and a second sidewall of the four side walls opposite to the first sidewall includes a second series of spaced apart apertures. A first elongated rail is attached to the first sidewall by a series of connections through the first series of spaced apart apertures. A second elongated rail is attached to the second sidewall by a series of connections through the second series of spaced apart apertures.

### FIELD

The present disclosure relates to a sink accessory railing system.

### BACKGROUND AND SUMMARY

This section provides background and summary information related to the present disclosure which is not necessarily prior art.

Sink accessory systems have become increasingly popular for supporting sink accessories such as a cutting board, a colander, a side sink, a bain maire, a salad spinner and a drying rack above the bottom surface in order to provide a multi-function sink system.

The present disclosure provides an improved sink accessory railing system that is easy to assemble/manufacture, that is easy to clean and that does not require complex sidewall structures as compared to existing sink systems.

A sink assembly according to the present disclosure includes a sink basin including a bottom surface having a drain and four side walls extending upward from the bottom surface. A first sidewall of the four side walls is provided with a first series of spaced apart apertures and a second sidewall of the four side walls opposite to the first sidewall includes a second series of spaced apart apertures. A first elongated rail is attached to the first sidewall by a series of connections through the first series of spaced apart apertures. A second elongated rail is attached to the second sidewall by a series of connections through the second series of spaced apart apertures.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a sink assembly having a rail system according to the principles of the present disclosure;

FIG. 2 is an exploded perspective view of a sink assembly having a rail system according to the principles of the present disclosure;

FIG. 3 is a cross-sectional view of an elongated rail according to the principles of the present disclosure;

FIG. 4 is a cross-sectional view of the weld connection for securing the elongated rail to the sink; and

FIG. 5 is a cross-sectional view of an alternative elongated rail according to the principles of the present disclosure.

Corresponding reference numerals indicate corresponding parts throughout the several views of the drawings.

### DETAILED DESCRIPTION

Example embodiments will now be described more fully with reference to the accompanying drawings.

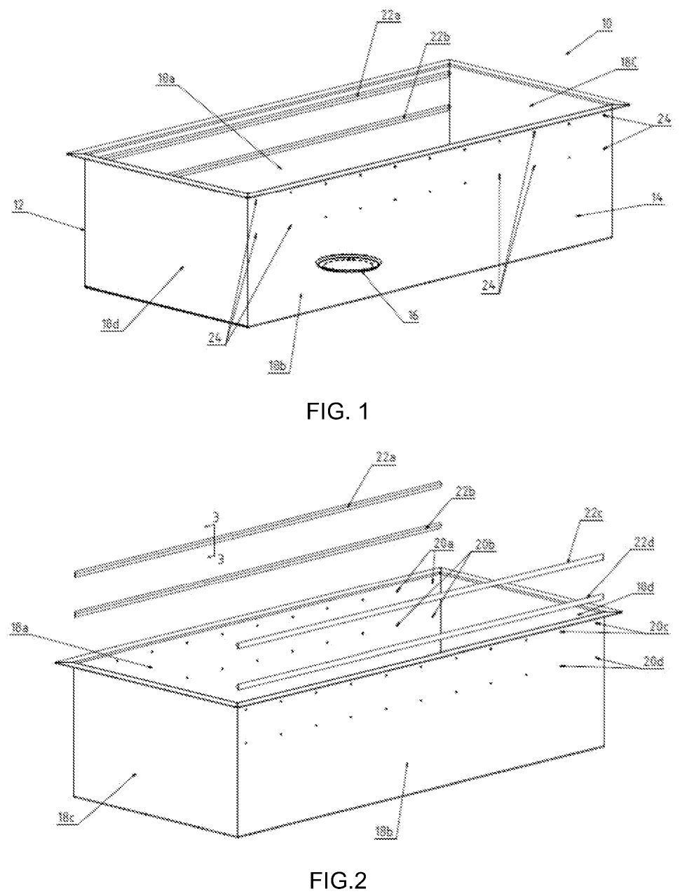

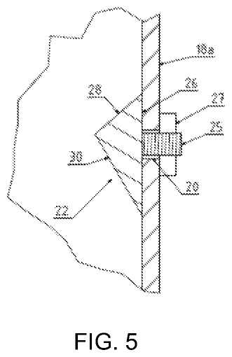

With reference to FIGS. 1 and 2, a sink assembly 10 is shown including a sink basin 12 having a bottom surface 14 with a drain 16 and four side walls 18a-d extending upward from the bottom surface 14. As best shown in the exploded, pre-assembled condition of FIG. 2, a first sidewall 18a of the four side walls 18a-d is provided with a first series of horizontally spaced apart apertures 20a and a second series of horizontally spaced apertures 20b and a second sidewall 18b of the four side walls 18a-d opposite to the first sidewall 18a includes a third series of horizontally spaced apertures 20c and a fourth series of horizontally spaced apertures 20d. In FIG. 2, four elongated rails 22a-d are shown prior to attachment to the first and second sidewalls 18a, 18b. With reference to FIGS. 1 and 4, the elongated rails 22a-d are shown attached to the first and second sidewalls 18a, 18b by a series of spot weld connections 24 through the first through fourth series of spaced apart apertures 20a-20d. The spot weld connections 24 are performed from an exterior side of the sink basin 12 and can sealingly close off the apertures 20a-20d. As shown in FIG. 5, alternative connections can be obtained by providing posts 25 on the rails 22 for extending through the apertures 20a-20d. The posts 25 can be threaded in order to receive a nut 27 thereon. As a further alternative, the posts 25 can be welded or soldered within the apertures 20a-20d.

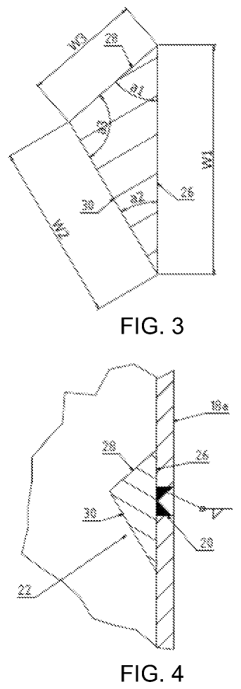

The sink basin 12 can be made from stainless steel or other sheet metal or cast material. The sidewalls 18a-d of the sink basin 12 can be generally planar and substantially vertical. The elongated rails 22a-d can be formed from stainless steel or other metallic or engineering materials. With reference to FIG. 3, the elongated rails 22a-d can have a triangular cross section. The triangular cross-section can be an obtuse scalene triangular cross-section. Accordingly, the elongated rails 22a-d include a first surface 26 that is disposed against the first and second sidewalls 18a, 18b and held in place by the weld connections 24 through the apertures 20a-20d. The elongated rails 22a-d include a second surface 28 facing upward away from the bottom surface 14 of the sink basin 12 and a third surface 30 facing downward toward the bottom surface 14. The first surface 26 has a first width w1 that is greater than a second width w2 of the second surface 28 and a third width w3 of the third surface 30, and wherein the second width w2 of the second surface 28 is smaller than the third width w3 of the third surface 30. In a preferred embodiment, the width w1 is 0.43 inches, the width w2 is 0.11 inches and the width w3 is 0.36 inches. Furthermore, in the embodiment shown, the angle a1 is 45°, the angle a2 is 13° and the angle a3 is 122°. The rails 22a-22d provide a narrow profile of 0.08 inches projecting inward from the sink sidewalls 18a, 18b.

The elongated rails 22a-d of the sink assembly 10 are provided for supporting one or more sink accessories (not shown) such as, but not limited to a cutting board, a colander, a side sink, a bain maire, a salad spinner and a drying rack above the bottom surface in order to provide a multi-function sink system. The use of two levels of elongated rails 22a, 22c; 22b, 22d allows for the sink accessories to be supported at alternative levels and to allow one accessory to be utilized overtop of another such as, but not limited to a cutting board or salad spinner above a side sink or a colander.

The elongated sink rails 22a-22d of the present disclosure are easily assembled to the sink sidewalls 18a, 18b in an un-obtrusive manner while allowing the sink sidewalls 18a-18d to be easily formed generally planar and substantially vertical. The elongated sink rails 22a-22d have a narrow profile (0.08 inches according to exemplary embodiment) projecting into the sink basin and allow the supporting flange of the sink accessories to be maintained on top of the rails 22a-22d and in close proximity to the sidewalls for centering the accessories along the rails while also allowing the second lower level of rails 22b, 22d to be in relatively close proximity to the upper level of rails 22a, 22c. The scalene obtuse triangular cross-section of the rails 22a-22d allow for easy cleaning of both the upper and lower surfaces 28, 30 of the rails 22a-22d in addition to providing easy access for cleaning the sidewalls 18a, 18b below the rails 22a-22d. The added rails 22a-22d also allow the sink sidewalls 18a, 18b to be step free without limiting/reducing the size of the bottom surface 14.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A sink assembly, comprising:
a sink basin including a bottom surface having a drain and four side walls extending upward from the bottom surface, wherein a first sidewall of the four side walls is provided with a first series of spaced apart apertures and a second sidewall of the four side walls opposite to the first sidewall includes a second series of spaced apart apertures;
a first elongated rail attached to the first sidewall by a series of connections through the first series of spaced apart apertures; and
a second elongated rail attached to the second sidewall by a series of connections through the second series of spaced apart apertures.

2. The sink assembly according to claim 1, wherein the first elongated rail and the second elongate rail are made from metal.

3. The sink assembly according to claim 2, wherein the first elongated rail is connected to the first sidewall by a weld connection through the first series of apertures and the second elongated rail is connected to the second sidewall by a weld connection through the second series of apertures.

4. The sink assembly according to claim 3, wherein the first elongated rail and the second elongated rail are triangular in cross section.

5. The sink assembly according to claim 4, wherein the triangular cross section of the first and second elongated rails includes a first surface disposed against the first and second sidewalls, a second surface facing upward away from the bottom surface of the sink basin and a third surface facing downward toward the bottom surface, the first surface having a first width that is greater than a second width of the second surface and a third width of the third surface, and wherein the second width is smaller than the third width.

6. The sink assembly according to claim 3, wherein the first sidewall includes a third series of spaced apart apertures and the second sidewall includes a further series of spaced apart apertures; and
further comprising a third elongated rail attached to the first sidewall by a series of connections through the third series of spaced apart apertures; and
a fourth elongated rail attached to the second sidewall by a series of connections through the fourth series of spaced apart apertures.

7. The sink assembly according to claim 6, wherein the first elongated rail, the second elongated rail, the third elongated rail and the fourth elongated rail are triangular in cross section.

8. The sink assembly according to claim 7, wherein the triangular cross section of the first, second, third and fourth elongated rails includes a first surface disposed against one of the first and second sidewalls, a second surface facing upward away from the bottom surface of the sink basin and a third surface facing downward toward the bottom surface, the first surface having a first width that is greater than a second width of the second surface and a third width of the third surface, and wherein the second width is smaller than the third width.

9. The sink assembly according to claim 2, wherein the first elongated rail is connected to the first sidewall by a plurality of threaded posts extending through the first series of apertures and the second elongated rail is connected to the second sidewall by a plurality of threaded posts extending through the second series of apertures.
